(19) United States
(12) Patent Application Publication
(10) Pub. No.: US 2025/0332931 A1
(43) Pub. Date: Oct. 30, 2025

(54) ELECTRIFIED VEHICLE

(71) Applicant: TOYOTA JIDOSHA KABUSHIKI KAISHA, Toyota-shi (JP)

(72) Inventors: Ayumu YAGETA, Nisshin-shi (JP); Masaru KIMURA, Toyota-shi (JP)

(73) Assignee: TOYOTA JIDOSHA KABUSHIKI KAISHA, Toyota-shi (JP)

(21) Appl. No.: 19/093,719

(22) Filed: Mar. 28, 2025

(30) Foreign Application Priority Data
Apr. 25, 2024 (JP) 2024-071909

(51) Int. Cl. B60L 50/70; B60L 58/33

(52) U.S. Cl. CPC B60L 50/70; B60L 58/33; B60L 2240/12; B60L 2240/622; B60L 2240/662

(57) ABSTRACT

A electrified vehicle comprising: a motor for traveling; a fuel cell or a power storage device that supplies electric power to the motor; an external power feed device that is connected to the power source via the power line and supplies electric power of the power line to the external load; a cooling device that cools the power source; and a control device that controls at least the cooling device, wherein the control device controls the cooling device such that the temperature of the power source is adjusted based on a first related amount that is a power feed time that is a time required for external power feed or a power feed amount that is a power amount required for external power feed, and a second related amount that is a distance to a destination or power consumption toward a destination after external power feed.

### CROSS-REFERENCE TO RELATED APPLICATION

This application claims priority to Japanese Patent Application No. 2024-071909 filed on Apr. 25, 2024, incorporated herein by reference in its entirety.

### BACKGROUND

### 1. Technical Field

The present disclosure relates to an electrified vehicle.

### 2. Description of Related Art

Conventionally, an electrified vehicle of this type has been proposed that includes a motor for traveling, a battery serving as a power source, an external power feed device, and a cooling device (e.g., see Japanese Unexamined Patent Application Publication No. 2020-54026 (JP 2020-54026 A)). The battery supplies power to the motor. The external power feed device executes external power feed for supplying output from the battery to an external load. The cooling device cools the battery. In this electrified vehicle, when a usage start operation of the external power feed device is performed, external power feed is started when margin output power is no less than a threshold value. Margin output power is a difference between an upper limit power that can be output by the battery and power that the battery is actually outputting.

### SUMMARY

However, in the above-described electrified vehicle, when external power feed is executed, power storage amount of the battery decreases. Accordingly, after performing external power feed, the vehicle may conceivably head toward a destination such as a charging station, to charge the battery. However, when the power storage amount in the battery is excessively reduced due to external power feed, there may be an inconvenience in that the electrified vehicle cannot reach the destination, due to lack of electric power after performing external power feed. A method of suppressing such inconvenience by raising the temperature of the battery to some extent is conceivable. In this method, the battery may be excessively heated during external power feed, and the output of the battery may be limited.

It is a primary object of the electrified vehicle according to the present disclosure run the power source at a more appropriate temperature.

The electrified vehicle of the present disclosure employs the following means in order to achieve above primary object.

An electrified vehicle according to the present disclosure includes
a motor for traveling, a power source that is a fuel cell or a power storage device for supplying power to the motor, an external power feed device that is connected to the power source via a power line and that executes external power feed for supplying power of the power line to an external load, a cooling device for cooling the power source, and a control device for controlling at least the cooling device.
   The control device controls the cooling device such that a temperature of the power source is adjusted based on a first related amount, that is a power feed time that is a time required for the external power feed or a power feed amount that is a power amount required for the external power feed, and a second related amount that is a distance or power consumption to a destination that is headed toward after the external power feed.

In the electrified vehicle according to the present disclosure, the cooling device is controlled such that the temperature of the power source is adjusted based on the first related amount, which is the power feed time that is the time required for the external power feed or the power feed amount which is the power amount required for the external power feed, and the second related amount that is a distance or power consumption to a destination that is headed toward after the external power feed. Accordingly, the temperature of the power source can be adjusted in accordance with the first related amount and the second related amount. As a result, the power source can be set to an appropriate temperature.

In such an electrified vehicle according to the present disclosure, when the external power feed is instructed, the control device may set a first temperature range that is a temperature range of the power source at a start of the external power feed enabling maintaining the temperature of the power source within an upper limit temperature of a temperature range that is allowed for the power source during the external power feed, based on the first related amount and outside air temperature, set a second temperature range that is a temperature range of the power source at the start of the external power feed that enables traveling to the destination, based on the second related amount, and control the cooling device such that before execution of the external power feed, the temperature of the power source is at a start-time temperature based on the first temperature range and the second temperature range. Thus, the temperature at which starting of the external power feed is executed is set to be appropriate, and the temperature of the power source can be suppressed from exceeding the upper limit temperature during the external power feed, and also the electrified vehicle can be made to travel to the destination after the external power feed.

In this case, the control device may set the start-time temperature such that the second temperature range is prioritized relative to the first temperature range. Thus, the electrified vehicle can be made to travel to the destination in a more sure manner after the external power feed.

In the electrified vehicle according to the present disclosure, in the form of setting the start-time temperature such that the second temperature range is prioritized relative to the first temperature range, when the first temperature range is not included in the second temperature range, the control device may set the start-time temperature to a temperature that is included in the second temperature range. Thus, the electrified vehicle can be made to travel to the destination in a more sure manner after the external power feed.

Further, in the electrified vehicle according to the present disclosure, the destination may be an energy supply facility. Thus, the electrified vehicle can be more made to travel to the energy supply facility in a more sure manner after the external power feed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram illustrating an outline of a configuration of an electrified vehicle 20 according to an embodiment of the present disclosure;

FIG. 2 is a schematic configuration diagram illustrating an outline of a configuration of the cooling device 40;

FIG. 3 is a flow chart illustrating an exemplary control routine executed by ECU 70;

FIG. 4 is an explanatory view illustrating an exemplary relation between the power feed time tps, the outside air temperature Tatm, and the upper limit temperature RT1max of the fuel cell 36 at the time of starting the external power feed, in which the temperature of the fuel cell 36 can be maintained below the upper limit temperature of the temperature range allowed for the fuel cell 36 during the power supply; and

FIG. 5 is an explanatory diagram for explaining an exemplary relation between the power feed time tps, the scheduled traveling distance Dst, the first temperature range RT1, the second temperature range RT2, and the start-time temperature Tfcst.

### DETAILED DESCRIPTION OF EMBODIMENTS

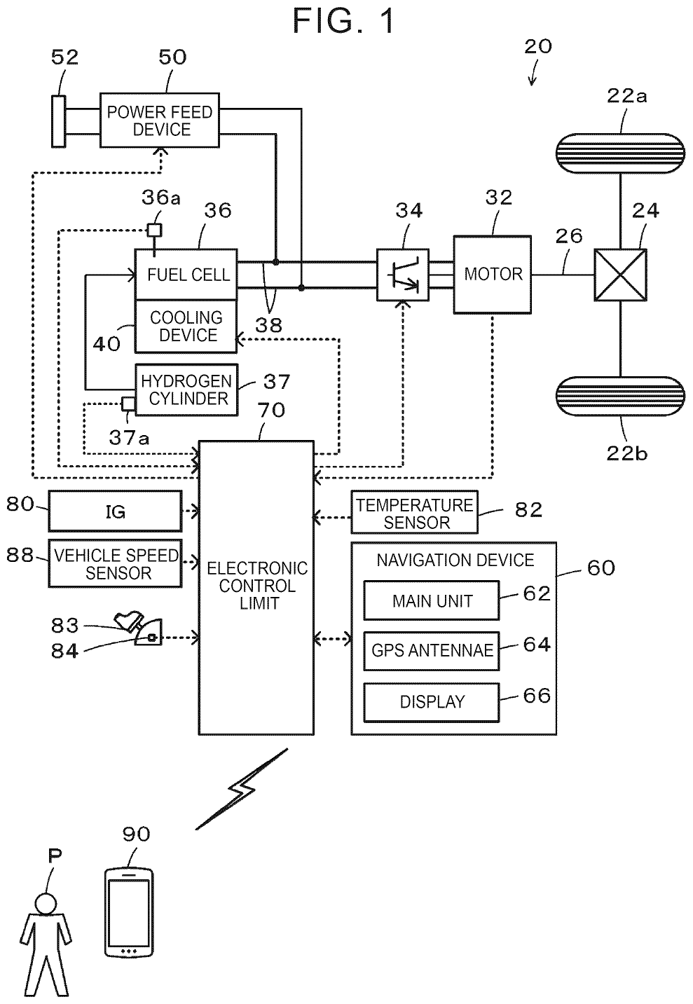

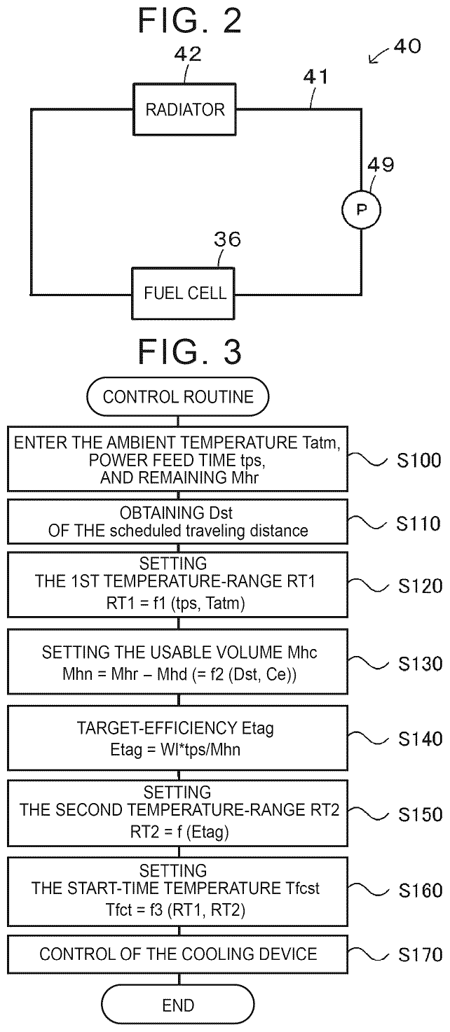

Embodiments of the present disclosure will be described with reference to the drawings. FIG. 1 is a schematic configuration diagram illustrating an outline of a configuration of an electrified vehicle 20 according to an embodiment of the present disclosure. FIG. 2 is a schematic configuration diagram illustrating an outline of a configuration of the cooling device 40. As shown in the drawing, electrified vehicle 20 includes a driving motor 32, an inverter 34, a fuel cell 36 as a power source, a cooling device 40, a power feed device 50, a navigation device 60, and an electronic control unit (hereinafter referred to as “ECU”) 70.

The motor 32 is connected to a drive shaft 26 in which a rotor is connected to a drive wheel 22a, 22b via a differential gear 24.

Inverter 34 is used to drive motor 32 and is connected to fuel cell 36 via power line 38. The motor 32 is rotationally driven by switching control of a plurality of switching elements (not shown) of the inverters 34 by an ECU 70.

The fuel cell 36 is a well-known solid polymer electrolyte fuel cell, has a stacked structure in which a plurality of single cells that are structural units are stacked, and functions as a high-voltage power supply (for example, several hundred volts). Each unit cell constituting the fuel cell 36 is supplied to the anode after the hydrogen gas is adjusted in pressure and flow rate by a hydrogen pump (not shown) from the hydrogen cylinder 37. Compressed air whose pressure is adjusted is supplied from the air compressor to the cathode, and a predetermined electrochemical reaction proceeds to generate an electromotive force. In the fuel cell 36, it is necessary to control the fuel cell 36 to a constant temperature range in order to exhibit high power generation efficiency.

As illustrated in FIG. 2, the cooling device 40 includes a radiator 42 and a cooling pump 49. The radiator 42 is incorporated in a circulation flow path 41 through which coolant circulates. The cooling pump 49 pumps the water in the circulation flow path 41. The cooling-pump 49 is controlled by an ECU 70.

The power feed device 50 is connected to the power line 38. The power feed device 50 is configured to be capable of supplying the DC power of the power line 38 (fuel cell 36) to the external device when the power receiving side connector of the external load that is not a component of the vehicle is connected to the power feed connector 52. The external loads are, for example, electric appliances, portable terminals, and battery electric vehicle capable of charging a battery mounted with external electric power. The DC power of the power line 38 is converted into AC power or DC power of a predetermined voltage (e.g., 100V or the like) and supplied. The number of the power feed connectors 52 is not limited to one, and may be two or more.

The navigation device 60 includes a main body 62 having a storage medium, such as a hard disk, in which map information and the like are stored, a CPU, ROM, RAM, an input/output port, and a communication port, and a GPS antennae 64 that receives information about the current location of the vehicles. Further, the navigation device 60 includes a touch panel type display 66 that displays various kinds of information such as map information, a current location of the own vehicle, and a route to be traveled to a destination, and allows a user to input various instructions. Here, the map information includes service information (for example, information on an energy supply facility such as a facility, a parking lot, a hydrogen station, and a charging facility), road information on each predetermined travel section (for example, between traffic lights and intersections), and the like. The road information includes distance information, width information, lane number information, area information (urban area or suburban area), type information (general road, expressway, toll road), gradient information, statutory speed, number of traffic lights, and the like. The navigation device 60 is connected to ECU 70 via a communication port. In the navigation device 60, when the user operates the display 66 to set the destination, the main body 62 sets the scheduled travel route from the current location to the destination based on the map information, the current location of the vehicle, and the destination. Then, the main body 62 displays the set travel scheduled route on the display 66, and performs route guidance.

ECU 70 is configured as a microprocessor centered on a CPU (not shown), and includes a ROM for storing a process program, a RAM for temporarily storing data, an input/output port, and a communication port in addition to CPU. In ECU 70, signals from various sensors are input via an input port. Examples of the signal inputted to ECU 70 include the battery temperature Tfc from the temperature sensor 36a for detecting the temperature of the fuel cell 36, the outside air temperature Tatm from the temperature sensor 82 for detecting the outside air temperature, and the remaining hydrogen amount Mhr from the remaining amount measuring 37a for detecting the remaining amount of the hydrogen cylinder 37. Examples include an ignition signal from the ignition switch 80, an accelerator operation amount Acc from the accelerator pedal position sensor 84 that detects a depression amount of the accelerator pedal 83, and a vehicle speed V from the vehicle speed sensor 88.

Various control signals are output from ECU 70 via an output port. The signal outputted from ECU 70 may be, for example, a control signal to the inverters 34.

As described above, ECU 70 is connected to the navigation device 60 via a communication port. ECU 70 is configured to be capable of wirelessly communicating with the mobile terminal 90. The mobile terminal 90 is configured as a portable computer such as a smartphone or a tablet terminal. The mobile terminal 90 is carried by the occupant P of electrified vehicle 20 and exchanges various types of data with electrified vehicle 20 by wirelessly or by wired communication. In the mobile terminal 90, an application for transmitting various instructions and various data related to external power feed to electrified vehicle 20 is installed. The application receives an instruction to execute external power feed from the user (occupant P) and a setting of a power feed time tps at the time of external power feed, and executes a process of transmitting the received instruction to electrified vehicle 20.

In electrified vehicle 20 of the embodiment, it is assumed that when the power feed connector 52 and the power receiving connector of the external load are connected during parking, the external power feed is instructed. Then, the power feed device 50 is controlled so that the electric power from the fuel cell 36 is supplied to the external load via the electric power line 38, thereby performing external power feed.

Further, in electrified vehicle 20 of the embodiment, in the cooling device 40, the fuel cell 36 is controlled to a constant temperature range by adjusting the water quantity of the cooling pump 49, so that the fuel cell 36 exhibits high-efficiency power generation. Regardless of the control of the cooling device 40, the power of the fuel cell 36 is limited when the upper temperature Tfcmax of the temperature range allowed by the fuel cell 36 is exceeded.

Next, the operation of electrified vehicle 20 of the present embodiment configured in this way, in particular, the operation when performing the external power feed will be described. FIG. 3 is a flow chart illustrating an exemplary control routine executed by ECU 70. This routine is executed when the power feed connector 52 and the power receiving connector of the external load are connected and the instruction of the external power feed from the mobile terminal 90 and the power feed time tps are received, that is, prior to the execution of the external power feed.

When this routine is executed, CPU of ECU 70 executes a process of inputting the outside air temperature Tatm, the power feed time (first related amount) tps, the scheduled traveling distance (second related amount) Dst, and the remaining hydrogen amount Mhr (S100). The outside air temperature Tatm is inputted as detected by the temperature sensor 82. The power feed time tps is received from the mobile terminal 90. The remaining hydrogen amount Mhr is obtained by inputting the remaining amount detected by the remaining amount measuring 37a.

Next, CPU of ECU 70 acquires the scheduled traveling distance Dst (S110). The scheduled traveling distance Dst is a traveling distance when electrified vehicle 20 travels to the nearest hydrogen station (energy supply facility) after the external power feed is performed. In this process, first, CPU of ECU 70 transmits, to the navigation device 60, a request to acquire the scheduled traveling distance Dst. Upon receiving the acquisition request, the navigation device 60 searches for a route to be traveled from the current position to the nearest hydrogen station based on the map information, the current position of the vehicle, and the position of the nearest hydrogen station. Then, the traveling distance from the current location from the searched scheduled traveling route to the nearest hydrogen station is acquired, and the acquired traveling distance is transmitted to ECU 70 as the scheduled traveling distance Dst. In S110, ECU 70 acquires the scheduled traveling distance Dst thus transmitted from the navigation device 60.

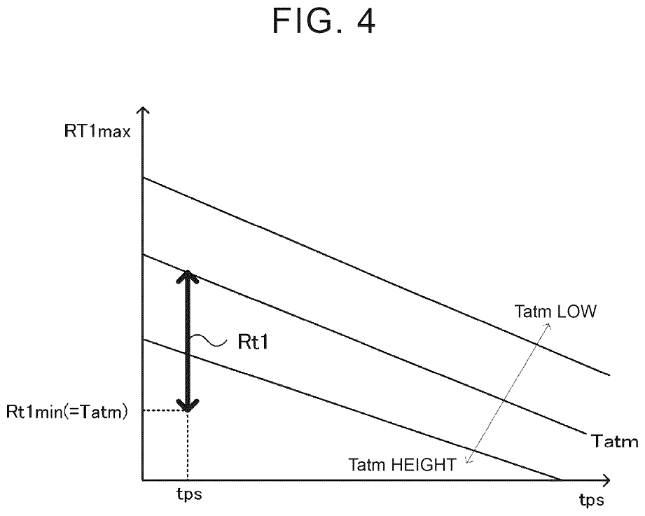

Subsequently, CPU of ECU 70 sets the first temperature range RT1 using the power feed time tps and the outside air temperature Tatm (S120). The first temperature range RT1 is a range of the temperature of the fuel cell 36 at the beginning of the external power feed in which the temperature of the fuel cell 36 can be maintained at a temperature equal to or lower than the upper limit temperature Tfcmax during the external power feed. FIG. 4 is an explanatory diagram illustrating an exemplary relation between the power feed time tps, the outside air temperature Tatm, and the upper limit temperature RT1max as the upper limit of the temperature of the fuel cell 36 at the time of starting the external power feed capable of maintaining the temperature of the fuel cell 36 to be equal to or lower than the upper limit temperature Tfcmax during the external power feed. As shown in the figure, the upper limit temperature RT1max is higher when the power feed time tps is long than when the power feed time is short, and is higher when the outside air temperature Tatm is high than when the power feed time is low. In FIG. 4, the upper limit temperature RT1max of the first temperature range RT1 sets an upper limit temperature RT1max corresponding to the case where the power feed time tps and the outside air temperature Tatm are given. Since the cell temperature of the fuel cell 36 is not lower than the outside air temperature Tatm, the outside air temperature Tatm is set to the lower limit temperature RT1 of the first temperature range RT1min. Therefore, when the temperature of the fuel cell 36 is in the first temperature range RT1 at the beginning of the external power feed, the temperature of the fuel cell 36 is suppressed from exceeding the upper limit temperature Tfcmax during the external power feed.

Next, CPU of ECU 70 sets the usable amount Mhc as the usable amount of hydrogen in the external power feed (S130). The usable amount Mhc is obtained by subtracting the converted value Mhd obtained by converting Pdst of electric energy consumed when traveling to the nearest hydrogen station after external charge into the amount of hydrogen from the present remaining hydrogen amount Mhr. The electric energy Pdst is calculated by multiplying the scheduled traveling distance Dst by electrified vehicle 20 electric energy cost Ce. The power cost Ce may be determined in advance by experimentation, analysis, machine-learning, or the like, or may be calculated while electrified vehicle 20 is running.

When the usable amount Mhc is set, ECU 70's CPU sets the power WI supplied to the external load multiplied by the power feed time tps divided by the usable amount Mhc to the target-efficiency Etag (S140). The electric power WI is electric power that is determined in advance by a standard or the like as electric power to be supplied to external loads. Note that the power WI may be received from external loads via communication.

Subsequently, CPU of ECU 70 sets a second temperature-range RT2 using the target-efficiency Etag (S150). The second temperature range RT2 is the temperature range of the fuel cell 36 at the beginning of the external power feed that can maintain the target-efficiency Etag at which electrified vehicle 20 can travel to the destination. In the setting of the second temperature range RT2, a temperature efficiency relationship, which is a relationship between the temperature of the fuel cell 36 and the power generation efficiency Egen, is determined in advance by experimentation, analysis, machine-learning, or the like. When the target efficiency Etag is set, a temperature range of the fuel cell 36 in which the power generation efficiency Egen is equal to or higher than the target efficiency Etag is set based on the temperature efficiency relationship. The second temperature range RT2 generally has the highest power generation efficiency Egen in the central portion of the temperature range, and has a lower power generation efficiency Egen as the distance from the central portion increases.

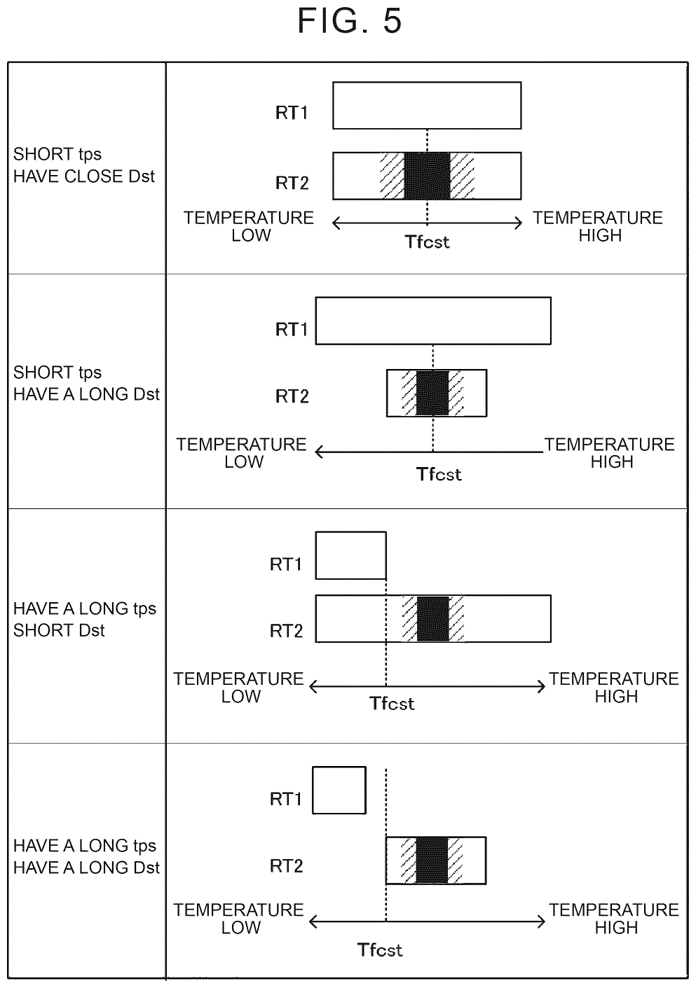

Then, CPU of ECU 70 sets a start-time temperature Tfest, which is the temperature of the fuel cell 36 when the external power feed is started, based on the first and second temperature ranges RT1, RT2 (S160). FIG. 5 is an explanatory diagram for explaining an exemplary relation between the power feed time tps, the scheduled traveling distance Dst, the first temperature range RT1, the second temperature range RT2, and the start-time temperature Tfcst. In the drawing, in the second temperature-range RT2, the black-filled region in the center portion is a region having a relatively higher power generation-efficiency Egen. The hatched area around the center has a lower power-generation-efficiency Egen than the black-filled area. The white-filled area outside the hatched area has a lower power-generation-efficiency Egen than the hatched area.

When all of the second temperature range RT2 are included in the first temperature range RT1, such as when the power feed time tps is short, as shown in FIG. 5, the temperature having the highest power generation efficiency Egen in the second temperature range RT2 is set to the start-time temperature Tfest. Since the start-time temperature Tfest is included in the first temperature range RT1, it is possible to prevent the power of the fuel cell 36 from being limited due to the increase in temperature. In addition, since the start-time temperature Tfest is the temperature having the highest power generation efficiency Egen in the second temperature range RT2, the power generation efficiency Egen of the fuel cell 36 can be increased to efficiently perform the external power feed. Accordingly, it is possible to suppress a decrease in the remaining amount of hydrogen in the hydrogen cylinder 37 during the external power feed, and it is possible to cause electrified vehicle 20 to travel to the destination after the external power feed. Therefore, the start-time temperature Tfest can be set to a temperature at which the limitation of the power output of the fuel cell 36 during the external charging and the travel to the destination after the external power feed can be made compatible with each other, and the fuel cell 36 can be set to a more appropriate temperature.

When a part of the second temperature range RT2 is included in the first temperature range RT1 and the remainder is not included in the first temperature range RT1, the highest temperature in the temperature range where the first temperature range RT1 and the second temperature range RT2 overlap is set to the start-time temperature Tfcst. This is the case when tps of power feed times is long and Dst of scheduled traveling distances is short. Since the start-time temperature Tfest is included in the first temperature range RT1, it is possible to prevent the power of the fuel cell 36 from being limited due to the increase in temperature. Since the start-time temperature Tfest is included in the second temperature range RT2 although the power generation efficiency Egen is not the highest temperature in the second temperature range RT2, the power generation efficiency Egen can be set to be equal to or higher than the target efficiency Etag. Accordingly, it is possible to suppress a decrease in the remaining amount of hydrogen in the hydrogen cylinder 37 during the external power feed, and it is possible to cause electrified vehicle 20 to travel to the destination after the external power feed. Therefore, the start-time temperature Tfest can be set to a temperature at which the limitation of the power output of the fuel cell 36 during the external charging and the travel to the destination after the external power feed can be made compatible with each other, and the fuel cell 36 can be set to a more appropriate temperature.

When there is no overlapping temperature range between the first temperature range RT1 and the second temperature range RT2, such as when the power feed time tps is long and the scheduled traveling distance Dst is long, the lowest temperature in the second temperature range RT2 is set to the start-time temperature Tfcst. The start-time temperature Tfest is not included in the first temperature range RT1, but the fuel cell 36 is unlikely to be at a high temperature as compared to the one in which the start-time temperature Tfest is set to a higher temperature in the second temperature range RT2 because it is the lowest temperature in the second temperature range RT2. Therefore, it is possible to prevent the output of the fuel cell 36 from being limited. Since the start-time temperature Tfest is included in the second temperature range RT2, the power generation efficiency Egen can be set to be equal to or higher than the target efficiency Etag. Accordingly, it is possible to suppress a decrease in the remaining amount of hydrogen in the hydrogen cylinder 37 during the external power feed, and it is possible to cause electrified vehicle 20 to travel to the destination after the external power feed. Therefore, the start-time temperature Tfcst can be set to a temperature at which the limitation of the power output of the fuel cell 36 during the external charging and the travel to the destination after the external power feed can be made compatible with each other, and the fuel cell 36 can be set to a more appropriate temperature.

When the start-time temperature Tfest is set, the cooling device 40 is controlled so that the temperature of the fuel cell 36 becomes the start-time temperature Tfest (S170), and the routine is ended. With such a process, the fuel cell 36 can be set to a temperature at which the restriction of the output of the fuel cell 36 during the external charging can be suppressed and the driving to the destination after the external power feed can be achieved at the same time, that is, a more appropriate temperature. When the temperature of the fuel cell 36 reaches the start-time temperature Tfcst, CPU of ECU 70 controls the power feed device 50 so that the external power feed is started, and starts the power supply to the external loads.

According to electrified vehicle 20 of the present embodiment described above, the cooling device 40 is controlled so that the temperature of the fuel cell 36 is adjusted based on the power feed time tps which is the time required for the external power feed and the scheduled traveling distance Dst which is the distance to the destination after the external power feed. Accordingly, the temperature of the fuel cell 36 can be set to a more appropriate temperature.

Further, when the external power feed is instructed, the first temperature range RT1 is set based on the power feed time tps and the outside air temperature Tatm, the second temperature range RT2 is set based on the scheduled traveling distance Dst, and the cooling device 40 is controlled so that the temperature of the fuel cell 36 becomes the start-time temperature Tfest based on the first temperature range RT1 and the second temperature range RT2 before the start of the external power feed. The first temperature range RT1 is a temperature range of the fuel cell 36 at the beginning of the external power feed in which the temperature of the fuel cell 36 can be maintained at a temperature equal to or lower than the upper limit temperature Tfcmax of the temperature range allowed for the fuel cell 36 during the external power feed. The second temperature range RT2 is a temperature range of the fuel cell 36 at the beginning of the external power feed that can travel to the destination. Accordingly, it is possible to prevent the temperature of the fuel cell 36 from exceeding the upper limit temperature Tfcmax during the external power feed, and it is possible to more reliably drive electrified vehicle 20 to the destination after the external power feed.

Further, by using the nearest hydrogen station as the destination, it is possible to more reliably drive electrified vehicle 20 to the hydrogen station.

In the above-described embodiment, when the first temperature range RT1 is not included in the second temperature range RT2, the start-time temperature Tfest is set to the lowest temperature in the second temperature range RT2, but the start-time temperature Tfcast may be set so that the second temperature range RT2 is prioritized as compared with the first temperature range RT1. For example, the start-time temperature Tfest may be a temperature included in the second temperature range RT2, such as a temperature higher than the lowest temperature in the second temperature range RT2. In this way, the power of the fuel cell 36 is limited during the external power feed, but electrified vehicle 20 can travel to the hydrogen-station.

In the above-described embodiment, when the external power feed is instructed, the first temperature range RT1 is set based on the power feed time tps and the outside air temperature Tatm. However, instead of the power feed time tps, a power feed amount that is a power amount required for external power feed may be used. In this case, the power feed amount may be obtained by multiplying the power WI by the power feed time tps.

In the above-described embodiment, the second temperature-range RT2 is set based on the scheduled traveling distance Dst. However, instead of the scheduled traveling distance Dst, the power consumed may be generated when the vehicle travels to a destination following the external power feed. In this case, the consumed electric power may be obtained by multiplying the scheduled traveling distance Dst by the electric power cost Ce.

In the above-described embodiment, when the external power feed is instructed, the first temperature range RT1 is set based on the power feed time tps and the outside air temperature Tatm. In addition, the second temperature-range RT2 is set based on the scheduled traveling distance Dst. Then, the cooling device 40 is controlled so that the temperature of the fuel cell 36 becomes a start-time temperature Tfest based on the first temperature range RT1 and the second temperature range RT2 prior to the start of the external power feed. However, the embodiment is not limited to setting the first temperature range RT1, the second temperature range RT2, and the start-time temperature Tfcst. Any cooling device may be used as long as the cooling device 40 is controlled so that the temperature of the fuel cell 36 is adjusted based on the power feed time tps and the scheduled traveling distance Dst.

In the above-described embodiment, the destination after the external power feed is the nearest hydrogen station (energy supply facility). However, the destination after the external power feed may be a destination set by a user different from the hydrogen station. When a rescue request (a request for external power feed) is received from another electrified vehicle who is absent from a server (not shown) via the mobile terminal 90, the destination may be a location where the other electrified vehicle is stopped.

In the above-described embodiment, ECU 70 receives an instruction for external power feed and power feed time tps from the mobile terminal 90. However, an instruction for external power feed or power feed time tps may be input via a display 66, a switch, or some other input device of the navigation device 60 mounted on electrified vehicle 20.

In the above-described embodiments, the present disclosure is applied to an electrified vehicle 20 in which the fuel cell 36 is mounted. However, the present disclosure may be applied to an electrified vehicle in which a power storage device such as a battery configured as a secondary battery such as a lithium-ion secondary battery is mounted instead of the fuel cell 36.

The correspondence between the main elements of the embodiments and the main elements of the disclosure described in the column of the means for solving the problem will be described. In the embodiment, the motor 32 corresponds to the “motor”, the fuel cell 36 corresponds to the “power source”, the power feed device 50 corresponds to the “external power feed device”, the cooling device 40 corresponds to the “cooling device”, and ECU 70 corresponds to the “control device”.

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of an electrified vehicle and the like.

What is claimed is:

1. An electrified vehicle comprising:
a motor for traveling;
a power source that is a fuel cell or a power storage device for supplying power to the motor;
an external power feed device that is connected to the power source via a power line and that executes external power feed for supplying power of the power line to an external load;
a cooling device for cooling the power source; and
a control device for controlling at least the cooling device, wherein
the control device controls the cooling device such that a temperature of the power source is adjusted based on a first related amount, that is a power feed time that is a time required for the external power feed or a power feed amount that is a power amount required for the external power feed, and a second related amount that is a distance or power consumption to a destination that is headed toward after the external power feed.

2. The electrified vehicle according to claim 1, wherein, when the external power feed is instructed, the control device sets a first temperature range that is a temperature range of the power source at a start of the external power feed enabling maintaining the temperature of the power source within an upper limit temperature of a temperature range that is allowed for the power source during the external power feed, based on the first related amount and outside air temperature, sets a second temperature range that is a temperature range of the power source at the start of the external power feed that enables traveling to the destination, based on the second related amount, and controls the cooling device such that before execution of the external power feed, the temperature of the power source is at a start-time temperature based on the first temperature range and the second temperature range.

3. The electrified vehicle according to claim 2, wherein the control device sets the start-time temperature such that the second temperature range is prioritized relative to the first temperature range.

4. The electrified vehicle according to claim 3, wherein, when the first temperature range is not included in the second temperature range, the control device sets the start-time temperature to a temperature that is included in the second temperature range.

5. The electrified vehicle according to claim 1, wherein the destination is an energy supply facility.
